(19) United States
(12) Patent Application Publication
(10) Pub. No.: US 2010/0026962 A1
(43) Pub. Date: Feb. 4, 2010

(54) Optical aberration compensating optic

(75) Inventor: Duane Scott Dewald, Dallas, TX (US)

Correspondence Address: COLLARD & ROE, P.C., 1077 NORTHERN BOULEVARD, ROSLYN, NY, 11576, US

(73) Assignee: Schneider Optics, Inc.

(21) Appl. No.: 12/220,998

(22) Filed: Jul. 30, 2008

(51) Int. Cl. G03B 21/14; G02B 3/06; G03B 21/28

(52) U.S. Cl. 353/33; 359/710; 353/121

(57) ABSTRACT

An optical element for compensating for aberrations in a projected image resulting from an air gap between adjacent segments of a separation prism includes a first surface and a second surface opposite said first surface. Each of the first and second surface define a portion of a cylinder having a radius and a cylindrical axis. The optical element is disposed between the separation prism and the projected image. A thickness of the optical element and the radius of the cylinder are selected to correspond to the aberration to be compensated and the cylindrical axis is oriented to correspond to the aberration to be compensated.

### BACKGROUND OF THE INVENTION

1. Field of the Invention

The invention relates to devices and methods for compensating for aberrations in a projected image. More particularly, the invention relates to optical elements for compensating for aberrations in a projected image resulting from an air gap between segments of a separation prism.

2. The Prior Art

Image projecting devices, such as digital light processing projectors, employ separation prisms for separating light provided by a light source into a plurality of colors and combining prisms for combining the individual colors into a full color image. The separation prism may be, for example, a red-green-blue (“RGB”) or “Phillips” type prism. The combining prism may be a total internal reflection (“TIR”) prism.

The separation prism includes a plurality of prism segments. One or more of the prism segments in the separation prism is separated from an adjacent prism segment by a relatively small air gap. For example, a basic RGB “Phillips prism may consist of three prism segments having angles which are designed to minimize the polarization of incoming light and to produce double reflections so that all output images have the same orientation as the input.

Light from a lens enters the bottom of the RGB prism through a surface of the prism perpendicular to the optical axis of the lens. The light may first pass through a band limiting filter. The light then strikes a first longpass filter that allows red and green light through, but reflect blue light. The longpass filter is backed by an air gap. A sealed edge, such as a thin film coating produces total internal reflection in the next segment. The blue light is reflected a second time a exits perpendicular to a blue face of the first filter.

The second filter or segment of the RGB prism is a shortpass type that reflects red light and passes green light. This filter does not require an air gap and may be glued to an adjacent third filter or segment. The red light is reflected a second time in the second filter and exits. The green light passes straight through and exits the third filter. The positions of the output faces of the prism segments are arranged so that the three optical path lengths are identical.

Because the air gaps in the separation prisms are tilted with respect to the optical axis of the projector, the air gaps result in aberrations in the projected image. Such aberrations include astigmatism and coma and may result in flare. Previously, the separation prism air gaps were kept to ten microns or smaller in order to minimize blurring of the image projected by the device.

In high brightness applications, however, such as digital cinema and large venue projection applications using digital light processing technology, thermal stresses building up in the separation prism can cause the prism to warp, expand or otherwise deform. This deformation can cause the separation prism air gap to shrink, for example to a distance of smaller then five microns, at which point the thin film coating that reflects certain colors of light will not operate properly.

In response to this problem of thermal stresses causing separation prism air gaps to shrink, resulting in failure of the separation prism, prism manufactures have increased the size of the air gaps, for example to twenty microns or larger. As a result of the larger air gaps, acceptable thermal stability of the separation prism is achieved, but the focus quality of the projected image is compromised. In particular, the larger prism air gaps result in such image aberrations as astigmatism and coma. Flare may result from the aberrations.

Accordingly, a need exists for an optical element for compensating for aberrations in a projected image resulting from an air gap between adjacent segments of a separation prism. In particular a need exists for such an optical element which can be incorporated into a projector, for example, a digital light processing projector, such as a cinema or large venue projector.

### SUMMARY OF THE INVENTION

The invention relates to devices and methods for compensating for aberrations in a projected image. More particularly, the invention relates to optical elements for compensating for aberrations in a projected image resulting from an air gap between segments of a separation prism. The invention further relates to projectors, for example digital light processing projectors incorporating an optical element for compensating for aberrations in a projected image.

An optical element for compensating for aberrations in a projected image resulting from an air gap between adjacent segments of a separation prism according to an aspect of the invention includes a first surface and a second surface opposite the first surface. Each of the first surface and the second surface define a portion of a cylinder having a radius and a cylindrical axis. The optical element is disposed between the separation prism and the projected image. The thickness of the optical element and the radius of the cylinder are selected to correspond to the aberration to be compensated and the cylindrical axis of the cylinder is oriented to correspond to the aberration to be compensated.

A projector for projecting an image according to an aspect of the invention includes a light source and a separation prism for separating light from the light source into a plurality of colors. The separation prism includes a plurality of prism segments with at least one air gap disposed between two adjacent prism segments.

The projector further includes a combining prism for combining the light reflected by the digital micro-mirror devices and a projection lens.

An optical element for compensating for aberrations in the projected image resulting from the air gap is disposed between the separation prism and the projected image. The optical element includes a first surface and a second surface opposite the first surface. Each of the first surface and second surface define a portion of a cylinder having a radius and a cylindrical axis. The thickness of the optical element and the radius of the cylinder are selected to correspond to the aberration to be compensated and the cylindrical axis of the cylinder is oriented to correspond to the aberration to be compensated.

In a further embodiment, the projector may be a digital light processing projector and a plurality of digital micro-mirror devices for reflecting the light separated by the separation prism is provided. Each of the digital micro-mirror devices is associated with a respective prism segment of the plurality of prism segments.

A method for compensating for aberrations in a projected image resulting from an air gap between adjacent segments of a separation prism according to an aspect of the invention includes the steps of providing an optical element disposed between the separation prism and the projected image. The optical element includes a first surface and a second surface opposite the first surface. Each of the first surface and the second surface define a portion of a cylinder having a radius and a cylindrical axis.

The method further includes the steps of selecting a thickness of the optical element to correspond to the aberration to be compensated, selecting the radius of the cylinder to correspond to the aberration to be compensated, and orienting the cylindrical axis to correspond to the aberration to be compensated.

An advantage of an optical element according to an embodiment of the invention is that aberrations in a projected image which result from an air gap between segments of a separation prism may be readily and inexpensively compensated, resulting in better resolution and focus quality.

A further advantage of an optical element according to an embodiment of the invention is that the optical element may be incorporated into a projector, for example a digital light processing (DLP) projector, a liquid crystal display (LCD) projector or a liquid crystal on silicon (LCOS) projector as original equipment or provided separately as an attachment to the projector. Moreover, the focus improvement achieved by the optical element does not have to be designed into the projection lens of the projector device.

A further advantage of an optical element according to an embodiment of the invention is that the optical element allows for the use of larger separation prism air gaps for higher power projecting applications without sacrificing the quality of the projected image. The optical element may allow for the use of increased air gaps by selecting the correct optical compensating elements and rotating the element to the proper angle.

A further advantage of an optical element according to the invention is that the optical element can be formed from inexpensive materials, such as BK7 glass, float glass, moldable glass or plastic. A plastic optical element according to an embodiment of the invention may be molded into a basic shape and the compensating effect of the optical element may be adjusted by applying force to the optical element, thereby increasing or decreasing its radius of curvature as appropriate.

### BRIEF DESCRIPTION OF THE DRAWINGS

Other benefits and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a ray fan plot showing the coma and astigmatism created by a 20 micron thick prism air gap tilted at 31 degrees;

FIG. 2 shows a spot diagram for the same conditions as in FIG. 1 without any lens refocusing;

FIG. 3 shows a ray fan plot for the same conditions as in FIG. 1 after the lens has been re-focused;

FIG. 4 shows a spot diagram for the same conditions as in FIG. 3 with re-focusing;

FIG. 5 shows a ray fan plot for the same conditions as in FIG. 1 wherein an optical element according to an embodiment of the invention has been introduced;

FIG. 6 shows a spot diagram for the same conditions as in FIG. 5 with the optical element according to an embodiment of the invention introduced;

FIG. 7 shows a plot of a relationship between coma and prism air gap thickness;

FIG. 8 shows a plot of a relationship between coma and air gap tilt;

FIG. 9 shows a schematic representation of a projector including an optical element according to an embodiment of the invention;

FIG. 10. shows the schematic representation of a projector as in FIG. 9, with the optical element disposed between a projection lens and a surface on which the image is projected; and

FIG. 11 shows the geometry of an optical element according to an embodiment of the invention.

### DETAILED DESCRIPTION OF THE DRAWINGS

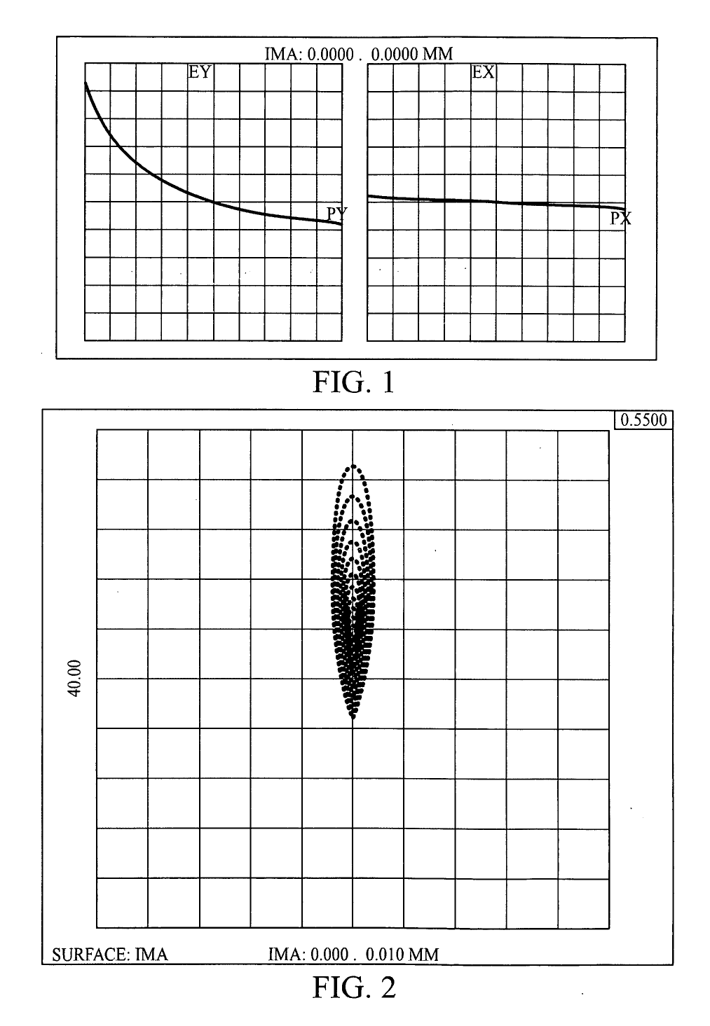

In image projecting devices, the two major aberrations caused by an air gap in a prism disposed between a lens and its image are coma and astigmatism. FIGS. 1 and 2 show an example of the coma and astigmatism created by a 20 micron thick prism air gap tilted at an angle of 31 degrees. The example assume a perfect lens at f/2.5.

FIG. 1 shows a standard transverse ray fan plot plotted on a maximum scale of 20 microns. The difference in the slope of the two lines indicates astigmatism. The upward curvature of the left plot (EY) indicates coma. As shown in FIG. 1, approximately 17 microns of coma are created in the example of a 20 micron thick prism air gap tilted at an angle of 31 degrees. Such a degree of coma would not be acceptable in image projection applications when focusing a pixel as small as 10 microns. FIG. 2 shows a spot diagram for the same conditions as in FIG. 1 without any lens refocusing. The axes scale of the diagram shown in FIG. 2 is 40 microns.

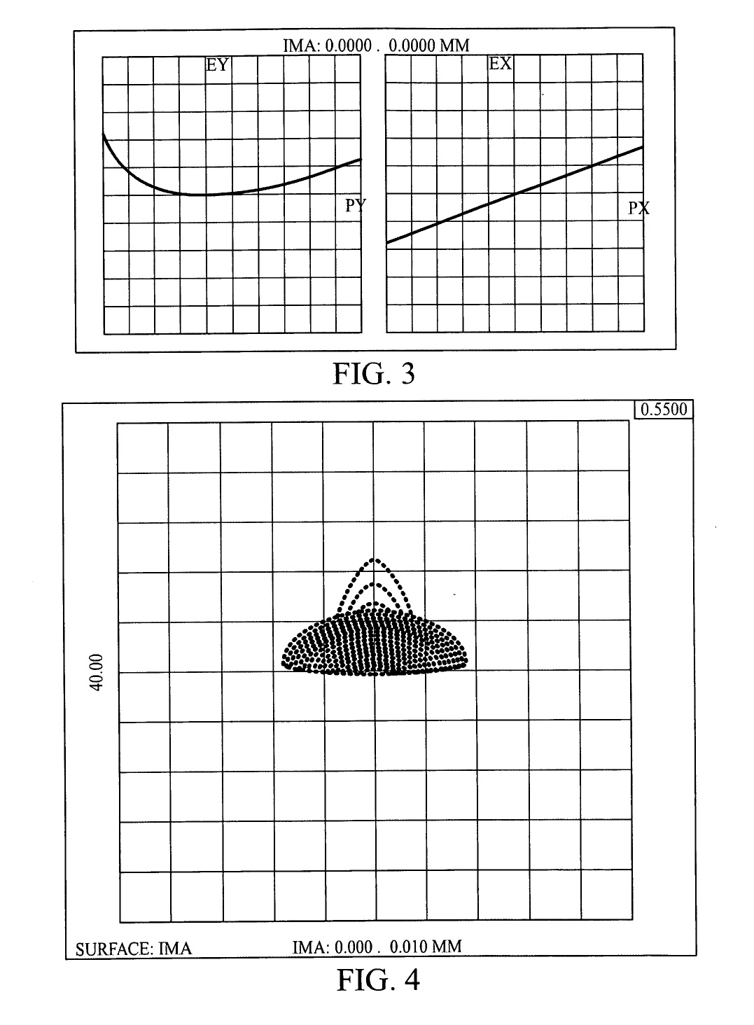

Typically, the lens would be refocused to minimize the effect of one aberration at the expense of making the other aberration worse. In the example shown in FIGS. 3 and 4, de-focus is created to balance the astigmatism. This yields the transverse ray fan plot shown in FIG. 3 and the spot diagram shown in FIG. 4.

In an embodiment of the invention, an optical element, which may be in the form of a cylindrical lens, is introduced between a separation prism having an air gap and the projected image. The optical element creates a balancing astigmatism. There are a multitude of combinations of cylindrical radii and thicknesses for the optical element which may achieve the desired balancing astigmatism. When the radii and thickness of the optical element according to an embodiment of the invention are properly chosen, the extent of the coma can be minimized and the astigmatism almost completely eliminated.

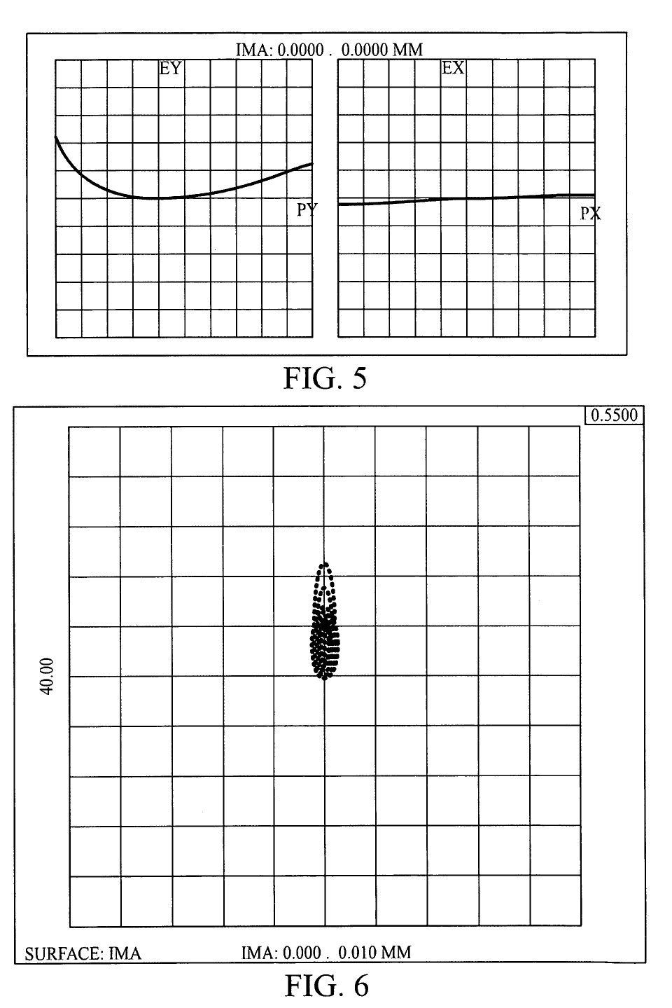

For example, FIG. 5 shows a transverse ray fan plot for the same conditions as in FIG. 1 wherein an optical element according to an embodiment of the invention has been introduced. Likewise, FIG. 6 shows a spot diagram for the same conditions as in FIG. 5 with the optical element according to an embodiment of the invention introduced. The spot diagram shown in FIG. 6 shows the concentration of the focused light near the center of the spot, as contrasted with the spot diagrams of FIGS. 2 and 4. Thus, as shown in FIG. 6, an optical element according to an embodiment of the invention creates a much more pleasing focus.

The amount of astigmatism and coma to be compensated for in a projection system is a function of the f/number, the prism thickness, the position of the air gap or gaps relative to the image, the air gap thickness, and the angle of tilt of the air gap. An optical element according to an embodiment of the invention would likely work in telecentric projection systems, such as for example, 3 chip digital light processing (DLP) projectors, liquid crystal display (LCD) projectors and liquid crystal on silicon (LCOS) projectors.

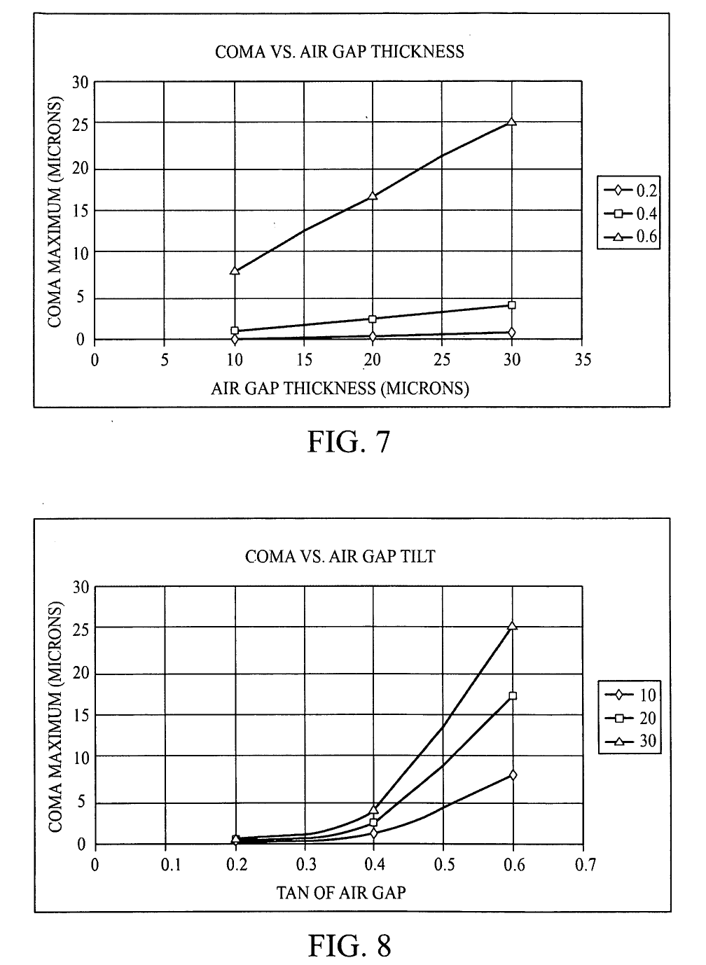

FIGS. 7 and 8 show some sensitivities of aberrations to the prism air gap. FIG. 7 shows a plot of a relationship between coma and prism air gap thickness and FIG. 8 shows a plot of a relationship between coma and air gap tilt. In particular, the amount of coma created at the edge of the lens pupil appears to be a linear function of prism air gap thickness and appears to scale with the third or fourth power of the tangent of the prism air gap tilt angle.

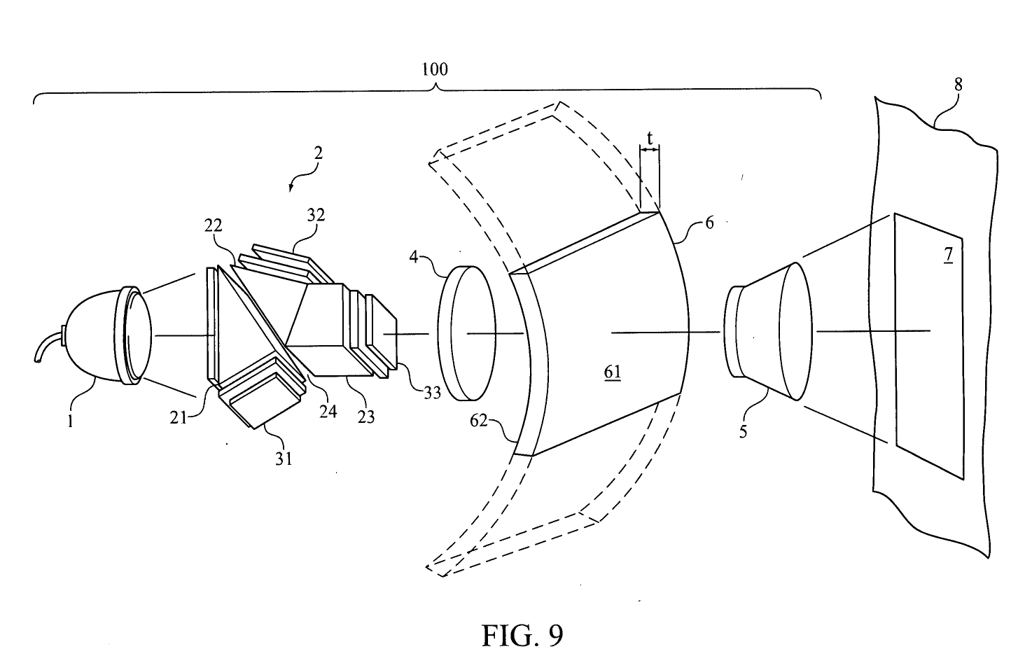

FIG. 9 shows a schematic representation of a projector 100 including an optical element according to an embodiment of the invention. Projector 100 is for projecting an image 7 onto a surface 8, such as a screen. Projector 100 may be a cinema or large venue projector. Projector 100 may be a digital light processing (DLP) projector, a liquid crystal display (LCD) projector, or a liquid crystal on silicon (LCOS) projector.

As shown, projector 100 includes a light source 1. Separation prism 2 separates light provided by light source 1 into a plurality of colors. Separation prism 2 includes a plurality of prism segments 21, 22, 23. Separation prism 2 may be, for example, a red-green-blue (“RGB”) or “Phillips” type prism including first prism segment 21, second prism segment 22 and third prism segment 23.

One or more of the prism segments 21, 22, 23 in the separation prism is separated from an adjacent prism segment by an air gap 24. For example, air gap 24 may separate first prism segment 21 and second prism segment 22.

Because air gap 24 in separation prism 2 is tilted with respect to the optical axis of the projector, the air gap 24 results in aberrations in the projected image 7. Such aberrations may include astigmatism and coma and may result in flare.

In high brightness applications, such as digital cinema and large venue projection applications, thermal stresses building up in the separation prism can cause the prism to warp, expand or otherwise deform. Accordingly, larger prism air gaps are used, for example, up to twenty microns or larger. As a result of the larger air gaps, acceptable thermal stability of the separation prism is achieved, but the focus quality of the projected image is compromised. As described herein, the aberrations in the projected image resulting from the prism air gap are compensated for by an optical element according to embodiments of the invention, resulting in substantially improved image quality.

An optical element 6 according to the invention may be effective in various types of projectors employing a prism having an air gap, such as for example, digital light processing (DLP) projectors, liquid crystal display (LCD) projectors and/or liquid crystal on silicon (LCOS) projectors

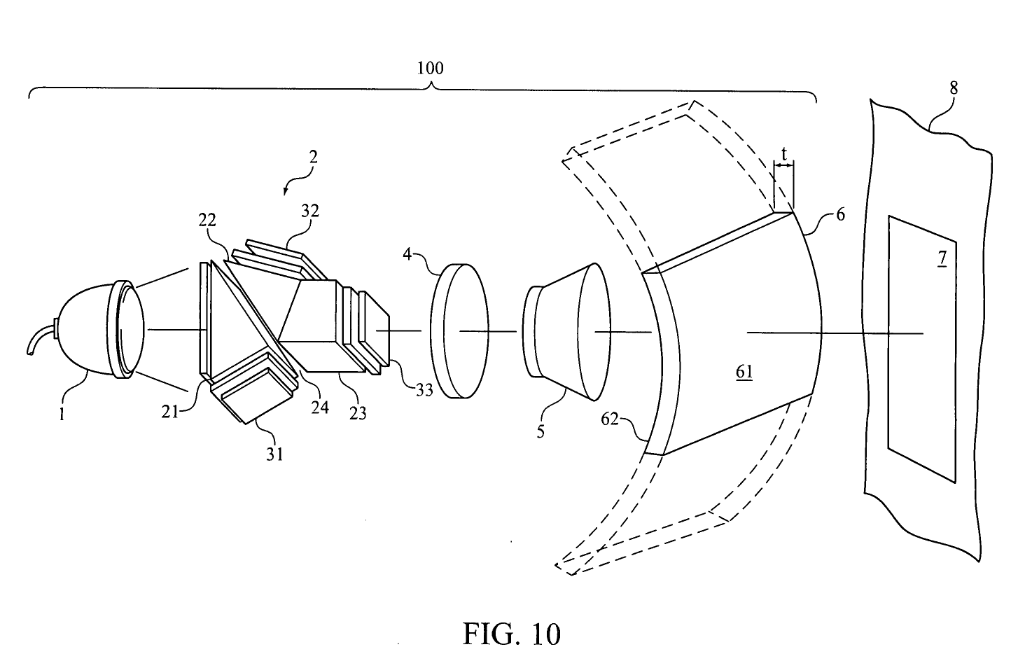

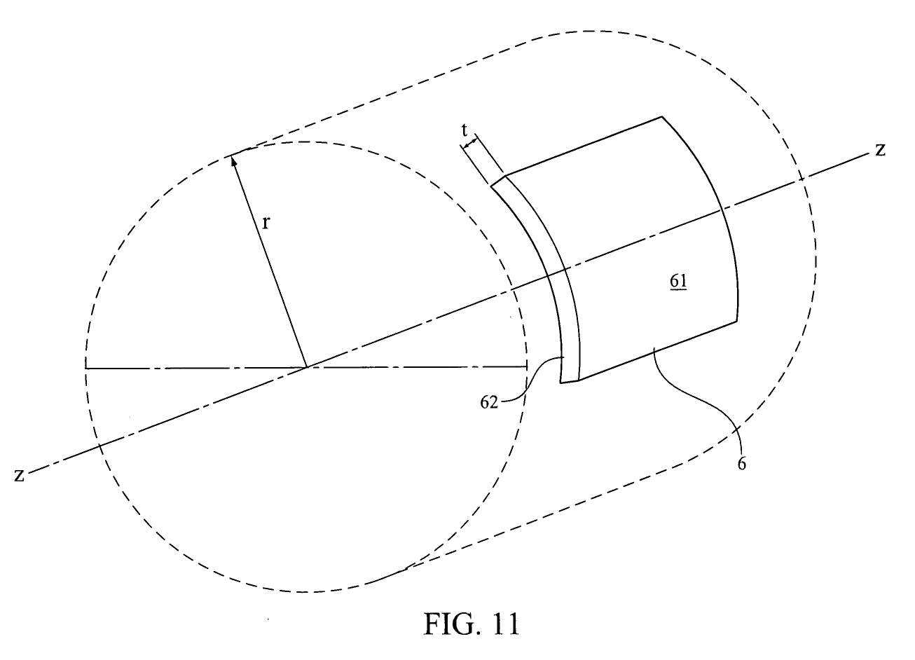

As shown in FIGS. 9 and 10, projector 100 may comprise a digital light processing projector having a plurality of digital micro-mirror devices 31, 32, 33. The digital micro-mirror devices reflect the light separated by the separation prism 2. The digital micro-mirror devices include a plurality of microscopic size mirrors laid out in a matrix on a semiconductor chip. Each of the digital micro-mirror devices may be associated with a respective prism segment of the separation prism 2. For example, first digital micro-mirror device 31 may be associated with and reflect the light exiting first prism segment 21, second digital micro-mirror device 32 may be associated with and reflect the light exiting second prism segment 22, and third digital micro-mirror device 33 may be associated with and reflect the light exiting third prism segment 23.

A combining prism 4 combines the light reflected by the micro-mirror devices 31, 32, 33 into a full color image. Combining prism 4 may be, for example, a total internal reflection (“TIR”) prism. A projection lens 5 is used to project image 7 onto a surface 8, such as, for example, a screen.

Optical or correcting element 6 is disposed between separation prism 2 and projected image 7 for compensating for aberrations in the projected image resulting from the prism air gap 24. Optical element 6 may be added between the separation prism 2 and the projection lens 5, as illustrated in FIG. 9 or between the projection lens 5 and a surface on which the image 7 is to be projected 8, such as a screen, as illustrated in FIG. 10 (image-side implementation).

The addition of correcting optical element 6 creates a balancing amount of astigmatism and/or coma. Once the projection lens has been re-focused slightly, a substantial improvement in the quality of the projected image is realized with the addition of optical element 6. For example, the required change in focus may be approximately twenty microns.

Optical element 6 includes a first or front surface 61 and a second or rear surface 62 opposite first surface 61. As shown, for example in FIG. 3, each of the first surface 61 and second surface 62 define a portion of a hypothetical circular cylinder having a radius r and a cylindrical axis z. The optical element 6 comprises a thin section of a cylinder with the radius of curvature of the first or front surface 61 being substantially equal to the radius of curvature of the second or rear surface 62.

The thickness t of optical element 6 and the radius r of the hypothetical cylinder defining the two surfaces of the optical element are selected to correspond to the aberration to be compensated. Additionally, the cylindrical axis z is oriented to correspond to the aberration to be compensated. In particular, the axis of the cylinder must be orientated such that it corresponds to the astigmatism created by the separation prism air gap, otherwise the optical element 6 may result in much poorer focus. As the thickness t and radius of curvature of optical element 6 determine the amount of balancing astigmatism produced, it is important to know the thickness and angle of the prism air gaps to be compensated.

For example, a thickness t of optical element 6 may be approximately 1.0-8.0 mm. More particularly, a thickness t of optical element 6 may be approximately 3.0-6.0 mm. A radius r of the hypothetical cylinder defining the curvature of the front and rear surface of the optical element 6 may be approximately 100-500 mm. More particularly, a radius r of the hypothetical cylinder defining the curvature of the front and rear surface of the optical element 6 may be approximately 300 mm.

The cylindrical axis z of the hypothetical cylinder defining the two surfaces of the optical element may be rotated to an angle of approximately thirty to sixty degrees with respect to the projected image. For example, the cylindrical axis may be oriented at forty five degrees to the image and aligned with the separating prism.

Optical element 6 may comprise a glass such as BK7, float glass or a moldable glass, such as, for example, Corning B270. Optical element 6 may also comprise a plastic material. Optical element 6 may also be formed or molded from a plastic material into a basic shape and then subjected to force to increase or decrease the radius of curvature of the optical element, thereby adjusting the amount of aberration correction as required.

Accordingly, while several embodiments of the present invention have been shown and described, it is obvious that many changes and modifications may be made thereunto without departing from the spirit and scope of the invention.

What is claimed is:

1. An optical element for compensating for aberrations in a projected image resulting from an air gap between adjacent segments of a separation prism, the optical element comprising:
a first surface and a second surface opposite said first surface, each of said first surface and said second surface defining a portion of a cylinder having a radius and a cylindrical axis; the optical element being disposed between the separation prism and the projected image;
wherein a thickness of the optical element and the radius of the cylinder are selected to correspond to the aberration to be compensated; and
wherein the cylindrical axis is oriented to correspond to the aberration to be compensated.

2. The optical element according to claim 1, wherein the optical element is disposed between the separation prism and a projection lens of a digital light processing projector.

3. The optical element according to claim 1, wherein the optical element is disposed between a projection lens of a digital light processing projector and a surface on which the projected image is viewed.

4. The optical element according to claim 1, wherein the thickness of the optical element is approximately 1.0-8.0 mm.

5. The optical element according to claim 4, wherein the thickness of the optical element is approximately 3.0-6.0 mm.

6. The optical element according to claim 1, wherein the radius of the cylinder is approximately 100-500 mm.

7. The optical element according to claim 1, wherein the optical element comprises a glass material.

8. The optical element according to claim 1, wherein the optical element comprises a plastic material.

9. A projector for projecting an image, the projector comprising:
a) a light source;
b) a separation prism for separating light from said light source into a plurality of colors, said separation prism comprising a plurality of prism segments and at least one air gap disposed between two adjacent prism segments of said plurality of prism segments;
c) a combining prism;
d) a projection lens; and
e) an optical element disposed between the separation prism and the projected image for compensating for aberrations in the projected image resulting from said at least one air gap, said optical element comprising a first surface and a second surface opposite said first surface, each of said first surface and said second surface defining a portion of a cylinder having a radius and a cylindrical axis;
wherein a thickness of the optical element and the radius of the cylinder are selected to correspond to the aberration to be compensated; and
wherein the cylindrical axis is oriented to correspond to the aberration to be compensated.

10. The projector according to claim 9, wherein the projector is a digital light processing projector further comprising a plurality of digital micro-mirror devices for reflecting the light separated by said separation prism and wherein each of said plurality of digital micro-mirror devices is associated with a respective prism segment of said plurality of prism segments.

11. The projector according to claim 9, wherein said optical element is disposed between said separation prism and said projection lens.

12. The projector according to claim 9, wherein the optical element is disposed between said projection lens and a surface on which the image is projected.

13. The projector according to claim 9, wherein the thickness of said optical element is approximately 1.0-8.0 mm.

14. The projector according to claim 13, wherein the thickness of said optical element is approximately 3.0-6.0 mm.

15. The projector according to claim 9, wherein the radius of the cylinder is approximately 100-500 mm.

16. The projector according to claim 9, wherein said optical element comprises a glass material.

17. The projector according to claim 9, wherein said optical element comprises a plastic material.

18. A method for compensating for aberrations in a projected image resulting from an air gap between adjacent segments of a separation prism, the method comprising the steps of:
a) providing an optical element disposed between the separation prism and the projected image, the optical element comprising a first surface and a second surface opposite said first surface, each of said first surface and said second surface defining a portion of a cylinder having a radius and a cylindrical axis;
b) selecting a thickness of the optical element to correspond to the aberration to be compensated;
c) selecting the radius of the cylinder to correspond to the aberration to be compensated; and
d) orienting the cylindrical axis to correspond to the aberration to be compensated.

19. The method according to claim 18, further comprising the step of applying a force to the optical element for increasing or decreasing the radius of the cylinder defined by the first surface and the second surface of the optical element.

20. The method according to claim 18, wherein the step of orienting the cylindrical axis further comprises rotating the cylindrical axis to an angle of approximately 30 to 60 degrees with respect to the projected image.
